(19) United States
(12) Patent Application Publication
(10) Pub. No.: US 2009/0095232 A1
(43) Pub. Date: Apr. 16, 2009

(54) Hands free extraction drag strap

(76) Inventor: Sean McKay, Greenville, SC (US)

Correspondence Address: MCNAIR LAW FIRM, P.A., P.O. BOX 447, GREENVILLE, SC, 29602-0447, US

(21) Appl. No.: 12/287,983

(22) Filed: Oct. 15, 2008

Related U.S. Application Data
(60) Provisional application No. 60/999,038, filed on Oct. 15, 2007.

(51) Int. Cl. A62B 35/00

(52) U.S. Cl. 119/770

(57) ABSTRACT

An elongated base strap with a top strap affixed to the base strap at a series of spaced anchor points. The top strap extends outward from the base strap between anchor points defining a plurality of consecutive attachment loops along the length of the base strap. A quick release coupling is carried at a first distal end for rapid detachment of the drag strap from a user. An extended end loop is carried at a second distal end of the base strap for engaging an injured person. A quick connect coupling is carried by the elongated end loop for coupling the elongated end loop to one of the attachment loops to secure the injured person to the drag strap, whereby a hands-free drag strap is provided for dragging an injured person to a safe location while allowing the rescuer to maintain engagement with a hostile combatant.

### CROSS REFERENCE TO RELATED APPLICATION

This application claims priority of Provisional Application Ser. No. 60/999,038, filed Oct. 15, 2007.

### BACKGROUND OF THE INVENTION

1) Field of the Invention

The present invention relates to safety and rescue extraction of downed or injured law enforcement, military or tactical operations personnel from a hostile combat environment, and more particularly, to a hands-free drag strap that will allow a user in a combat situation to drag an injured person to safety without compromising the rescuer's ability to maintain engagement with an enemy.

2) Description of Related Art

Today, tactical law enforcement and military personnel face more challenges than ever and the threats are increasingly more dangerous. Rescuers working to remove injured personnel in a hostile combat environment also face many challenges. Traditional methods of removing an injured person typically require three to four people on average to grab the injured person anyway they can and drag them to safety. These methods are time consuming, overly strenuous, unreliable, and expose the rescuers to increased threat as they lower their guard to rescue the injured person. For example, grabbing the protective vest or other gear of the injured person to drag them to safety can make it difficult to obtain sufficient leverage for moving quickly. Also, it is difficult to obtain a good grip and the section being grabbed may fail from the weight when the person is being dragged. In particular, current methods create unnecessarily longer exposure times on the “X” for the rescuers, subjecting both the rescuers and injured person to continued hostile fire. Further, current extraction methods tend to cause the rescuer to disengage from the enemy when attempting to grab the injured person, leading to deadly results.

In short, prior methods of rapid extraction took more people, more time, and left the rescuer(s) and injured person exposed to the threat. Accordingly, a need was realized for a more efficient way to remove injured personnel that is quick, reliable, and limits dangerous exposure of the rescuers and the injured person during extraction.

Thus, it is an object of the present invention to provide a rapid extraction hands-free drag strap which not only reduces the number of people required to drag a person to safety, but also the amount of time and effort needed to do so.

It is a further object of the present invention to provide a drag strap that is adjustable to accommodate the height of the user and variations in terrain when attaching to an injured person.

It is a further object of the present invention to provide a hands-free drag strap that allows a rescuer to drag the user to a safe location without having to disengage his weapon from the enemy.

It is a further object of the present invention to provide a drag strap that promotes a preferred posture for the rescuer to drag the injured person in an efficient manner.

### SUMMARY OF THE INVENTION

The above objectives are accomplished according to the present invention by providing a hands-free drag strap comprising an elongated base strap defining a predetermined length of the drag strap; a top strap affixed to the base strap at a series of spaced anchor points, wherein the top strap is extended outward from the base strap between the anchor points to define an attachment loop so that a plurality of consecutive attachment loops are provided along the length of the base strap; a quick release coupling carried at a first distal end of the base strap for attaching the drag strap to a user and providing rapid detachment of the drag strap from a user; an extended end loop carried at a second distal end of the base strap for engaging an injured person; and, a quick connect coupling carried by the elongated end loop for coupling the elongated end loop to one of the attachment loops to secure the injured person to the drag strap; whereby a hands-free drag strap is provided for dragging an injured person to a safe location while allowing the rescuer to maintain engagement with a hostile combatant.

In a further embodiment, the quick release coupling includes a hinged securing clasp operatively associated with a release pin engaging the securing clasp when in a closed position, wherein lateral movement of the release pin causes disengagement of the pin from the securing clasp allowing the securing clasp to open.

In a further embodiment, the release pin includes a first distal end engaging the securing clasp when in a closed position, and a second distal end carrying an elongated release strap to facilitate operation of the release pin to retract the first distal end of the pin from the securing clasp to open the securing clasp.

In a further embodiment, the quick connect coupling includes an oblong metal ring with a spring clip for rapid attachment to one of the attachment loops.

In a further embodiment, the anchor points are located approximately every 2.5 inches along the base strap to provide spacing between the attachment loops.

In a further embodiment, the anchor points include triple bar-tacked stitching of the top strap to the base strap to resist separation of the top strap from the base strap and reinforcing each of the attachment loops. In a further preferred embodiment, the bar-tacked stitching includes three rows of stitched thread generally extending across the width of the top strap and the base strap with each of the rows being spaced approximately ¼ inches apart so that each of the anchor points is approximately ½ inches in overall length.

In a further embodiment, the top strap layer and the base strap layer comprise foldable woven nylon tape.

In a further embodiment, the nylon tape has a tensile strength of approximately 4200 lbs. to resist breakage under heavy loads.

In a further embodiment, the base strap is folded back on itself to form the extended end loop and the top strap so that a single piece of material can be used to construct the drag strap.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a rescuer dragging an injured person in a head first arrangement using the hands-free drag strap according to the present invention;

FIG. 2 shows a rescuer dragging an injured person in a feet first arrangement using the hands-free drag strap according to the present invention;

FIG. 3 shows a rescuer dragging an injured person in a head first arrangement using the hands-free drag strap in an alterative attachment method according to the present invention;

FIG. 4 shows a perspective view of the hands-free drag strap according to the present invention;

FIG. 5 shows a side elevation view of a first distal end of the hands-free drag strap having a quick release coupling according to the present invention; and,

FIG. 6 shows a side view of a portion of the hands-free drag strap according to the present invention.

### DETAILED DESCRIPTION OF A PREFERRED EMBODIMENT

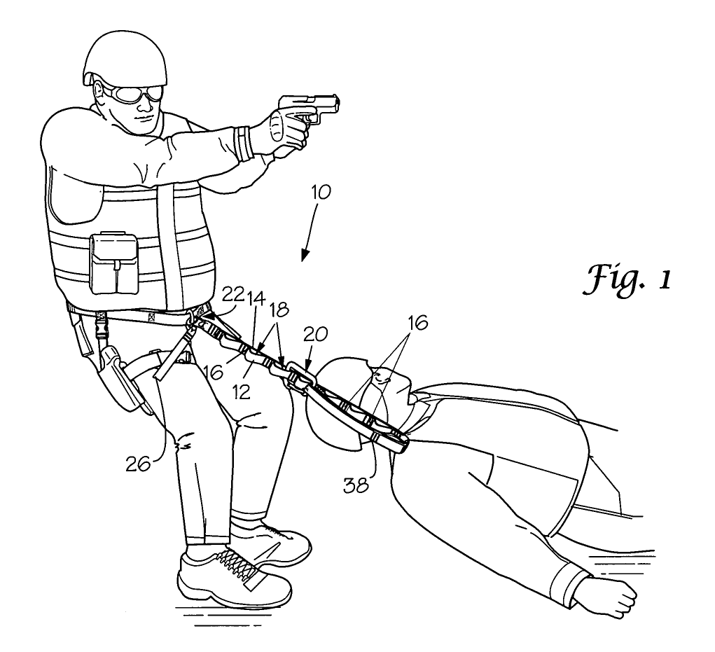

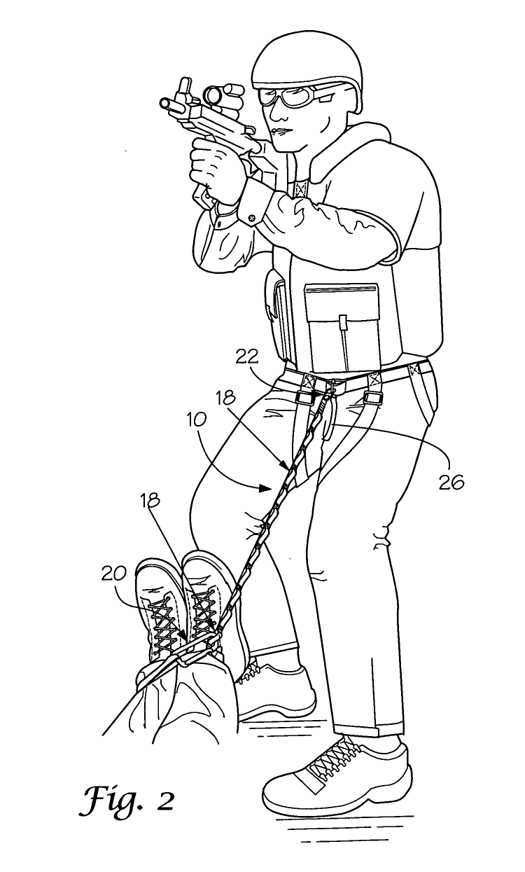

With reference to the drawings, the invention will now be described in more detail. Referring to FIGS. 1-3, a hands-free extraction drag strap, designated generally as 10, is shown. Drag strap 10 can be used in a hands-free arrangement and attached to an injured person in a variety of methods to extract the injured person from a combat environment without the rescuer exposing himself in a position that would prevent him from returning fire on hostile combatants.

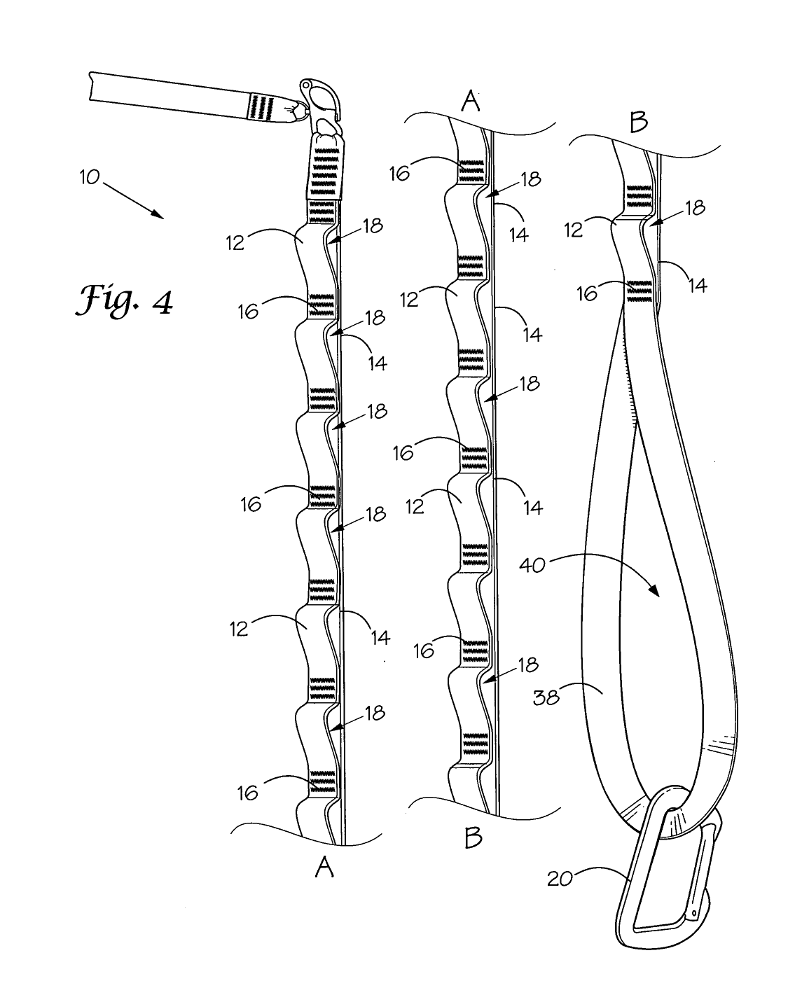

Referring to FIG. 4, drag strap 10 preferably consists of a high tensile strength foldable webbing material, such as woven nylon tape. Preferably, a single strip of nylon tape is folded back on itself in an overlapping manner to define a top strap 12, base strap 14 and extended end loop 40. Top strap 12 and base strap 14 are stitched together at various anchor points, designated generally as 16, along the length of the strap. In a preferred embodiment, the overall length of drag strap 10 is approximately 62 inches.

Top strap 12 is extended outward from base strap 14 between anchor points 16 to define an attachment loop, designated generally as 18, so that a plurality of consecutive attachment loops 18 are provided along the length of base strap 14. Each attachment loop 18 of top strap 12 forms a separate attachment point for receiving a quick connect coupling 20 carried by an extended end loop 40 at second distal end 38. The consecutive attachment loop arrangement allows the user of drag strap 10 to vary the attachment length to accommodate the height of the rescuer and the terrain of the rescue site for attachment to the person being rescued to avoid an excessively long or short drag strap or effect a particular type of dragging method, such as shortening the strap in a head first drag to raise the head of the injured person off the ground.

The consecutive attachment loop 18 arrangement of top strap 12 also protects against a total failure of drag strap 10. In the event one of anchor points 16 securing top strap 12 and base strap 14 together fails, quick connect coupling 20 would simply slip to the next reinforced attachment loop 18 and stop and the next anchor point 16, avoiding a complete failure of drag strap 10. Total failure of drag strap 10 would require each reinforced attachment loop 18 to fail and then top and base straps 12 and 14 to break, a highly unlikely scenario if used for its intended purpose as a single layer of high tensile strength nylon tape can support approximately 1 ton of weight. Thus, drag strap 10 provides extreme redundancy and strength to protect against failure for its intended use.

Referring to FIG. 6, anchor points 16 are located approximately every 2.5 inches along base strap 14, measured from the center of one anchor point to another and designated generally as A, to provide spacing between attachment loops 18. Preferably, anchor points 16 are triple bar-tacked stitching on top strap 12 to base strap 14 to resist separation of the top strap from the base strap and reinforce each of the attachment loops. In a further preferred embodiment, the bar-tacked stitching includes three rows of stitched thread generally extending across the width of top strap 12 and base strap 14 with each of the rows being spaced approximately ¼ inches apart, designated generally as C, so that each of anchor points 16 is approximately ½ inches in overall length, designated generally as B.

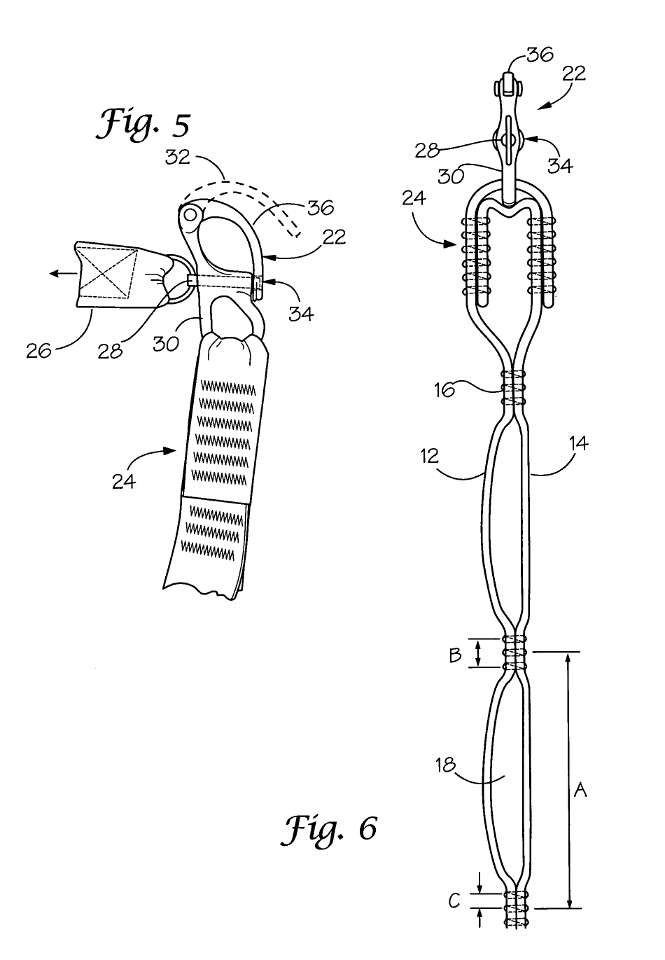

Referring to FIG. 5, a quick release coupling 22 is carried at a first distal end 24 of drag strap 10 for attachment to the rescuer's belt or other convenient attachment point to provide rapid detachment of drag strap 10 from the user. Quick release coupling 22 includes a hinged securing clasp 36 operatively associated with a release pin 28 engaging securing clasp 36 when in a closed position, wherein lateral movement of release pin 28 causes disengagement of the pin from securing clasp 36 allowing the securing clasp to open to position 32. Release pin 28 includes a first distal end 34 engaging securing clasp 36 when in a closed position, and a second distal end carrying an elongated release strap 26 to facilitate operation of release pin 28 to retract first distal end 34 of pin 28 from securing clasp 36 to open the securing clasp. In operation, release pin 28 is spring biased to direct first distal end 34 out of housing 30 of quick release coupling 22 to engage securing clasp 36. First distal end 34 of release pin 28 is retracted into housing 30 when release strap 26 is pulled. This allows securing clasp 36 to instantly release and open to position 32 in the event drag strap 10 needs to be disconnected.

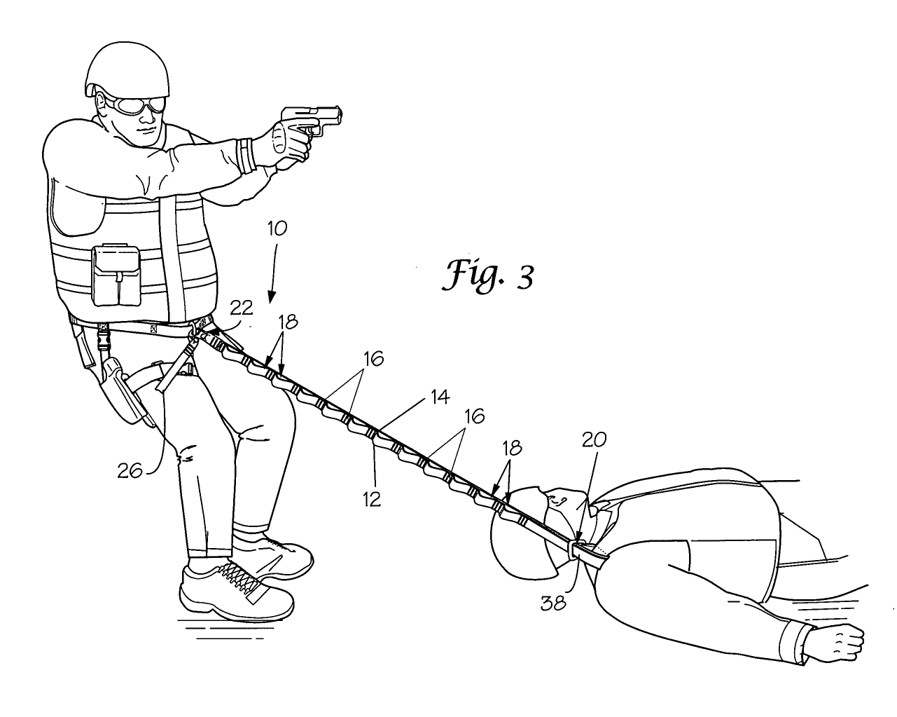

Referring to FIG. 4, quick connect coupling 20 includes an oblong metal ring with a spring clip for rapid attachment to one of the attachment loops, for example, a carabineer or like clip. Referring to FIG. 1, in a primary attachment method for a head first drag, second distal end 38 of drag strap 10 can be wrapped around a portion of the injured person or their personal protective equipment and then quick connect coupling 20 carried by end loop 40 can be attached back onto any of attachment loops 18 to provide a desired overall strap length. In an alternative attachment method for a feet first drag, after looping distal end 38 of drag strap 10 around the feet of a person being rescued, quick connect coupling 20 is attached to one of attachment loops 18 to provide a secure connection to the injured person. Referring to FIG. 3, as part of the versatility in use of drag strap 10, quick connect coupling 20 can alternatively be attached directly to distal end 38 after being looped around a portion of the injured person to provide a sliding arrangement that cinches around the injured person to provide a secure connection when the rescuer pulls on drag strap 10.

Further, second distal end 38 is constructed and arranged to form a large multi-purpose extended end loop, designated generally as 40, as compared to reinforced attachment loops 18. End loop 40 can alternatively be placed around a portion of an injured person in the event there is not a usable location to clip quick connect coupling 20, further adding to the adaptability of drag strap 10 to quickly adjust and accommodate to field conditions.

In summary, this unique extraction tool is ideal for shield-assisted, open-field and indoor-corridor rescues. The innovative daisy-chain configuration is designed to offer multiple reinforced attachment loops 18 for accommodating the height of the rescuer and the terrain of the rescue site. Preferably, drag strap 10 is constructed of 1″ Tech Tape with a tensile strength of approximately 4200 lbs. Drag strap 10 also features a quick release coupling 22 for rapid detachment as well as a quick connect coupling 20 and multi-purpose end loop 40 to provide adaptability in attaching drag strap 10 to an injured person. Use of this tool as intended allows the rescuer to maintain engagement with threat during the extraction process, thus minimizing deadly exposure on the “X”. Drag strap 10 promotes and utilizes improved body mechanics by maintaining an anatomically correct posture and increased leverage to rapidly extract larger weight persons in a quick and efficient manner, thus again minimizing deadly exposure on the “X”. Use of drag strap 10 also allows the injured person to maintain a natural prone posture and positions that preclude shifting of personal protective equipment (ppe) that either obviates that equipment or exposes additional unprotected body regions, as well as keeping the profile of the injured person to a minimum through horizontal dragging. Use of drag strap 10 also leads to decreased manpower needs in zeroed in location by allowing a single person to do a job that has traditionally been done by three to four people.

While a preferred embodiment of the invention has been described using specific terms, such description is for illustrative purposes only, and it is to be understood that changes and variations may be made without departing from the spirit or scope of the following claims.

What is claimed is:

1. A hands-free drag strap comprising:
an elongated base strap defining a predetermined length of said drag strap;
a top strap affixed to said base strap at a series of spaced anchor points, wherein said top strap is extended outward from said base strap between said anchor points to define an attachment loop so that a plurality of consecutive attachment loops are provided along the length of said base strap;
a quick release coupling carried at a first distal end of said base strap for attaching said drag strap to a user and providing rapid detachment of said drag strap from a user;
an extended end loop carried at a second distal end of said base strap for engaging an injured person; and,
a quick connect coupling carried by said elongated end loop for coupling said elongated end loop to one of said attachment loops to secure the injured person to said drag strap;
whereby a hands-free drag strap is provided for dragging an injured person to a safe location while allowing the rescuer to maintain engagement with a hostile combatant.

2. The drag strap of claim 1 wherein said quick release coupling includes a hinged securing clasp operatively associated with a release pin engaging said securing clasp when in a closed position, wherein lateral movement of said release pin causes disengagement of said pin from said securing clasp allowing said securing clasp to open.

3. The drag strap of claim 2 wherein said release pin includes a first distal end engaging said securing clasp when in a closed position, and a second distal end carrying an elongated release strap to facilitate operation of said release pin to retract said first distal end of said pin from said securing clasp to open said securing clasp.

4. The drag strap of claim 1 wherein said quick connect coupling includes an oblong metal ring with a spring clip for rapid attachment to one of said attachment loops.

5. The drag strap of claim 1 wherein said anchor points are located approximately every 2.5 inches along said base strap to provide spacing between said attachment loops.

6. The drag strap of claim 1 wherein said anchor points include triple bar-tacked stitching of said top strap to said base strap to resist separation of said top strap from said base strap and reinforcing each of said attachment loops.

7. The drag strap of claim 6 wherein said bar-tacked stitching includes three rows of stitched thread generally extending across the width of said top strap and said base strap with each of said rows being spaced approximately ¼ inches apart so that each of said anchor points is approximately ½ inches in overall length.

8. The drag strap of claim 1 wherein said top strap layer and said base strap layer comprise foldable woven nylon tape.

9. The drag strap of claim 8 wherein said nylon tape has a tensile strength of approximately 4200 lbs. to resist breakage under heavy loads.

10. The drag strap of claim 1 wherein said base strap is folded back on itself to form said extended end loop and said top strap so that a single piece of material can be used to construct said drag strap.

11. A hands-free drag strap comprising:
a base strap;
a top strap affixed to said base strap at a series of spaced anchor points;
a chain of attachment loops defined by said top strap and said anchor points along the length of said base strap;
a quick release coupling carried at a first distal end of said base strap for rapid detachment; and,
a quick connect coupling carried at a second distal end of said base strap for coupling to one of said attachment loops;
whereby a hands-free drag strap is provided for dragging an injured person to a safe location while allowing the rescuer to maintain engagement with a hostile combatant.

12. The drag strap of claim 11 including an extended end loop carried at a second distal end of said base strap for engaging an injured person, wherein said quick connect coupling is disposed on said extended end loop.

13. The drag strap of claim 12 wherein said base strap is folded back on itself to form said extended end loop and said top strap so that a single piece of material can be used to construct said drag strap.

14. The drag strap of claim 11 wherein said quick release coupling includes a hinged securing clasp operatively associated with a release pin engaging said securing clasp when in a closed position, wherein lateral movement of said release pin causes disengagement of said pin from said securing clasp allowing said securing clasp to open.

15. The drag strap of claim 11 wherein said quick connect coupling includes an oblong metal ring with a spring clip for rapid attachment to one of said attachment loops.

16. The drag strap of claim 11 wherein said anchor points include triple bar-tacked stitching of said top strap to said base strap to resist separation of said top strap from said base strap and reinforcing each of said attachment loops.
